(19) United States
(12) Patent Application Publication
(10) Pub. No.: US 2007/0028588 A1
(43) Pub. Date: Feb. 8, 2007

(54) Heat transfer apparatus and systems including the apparatus

(75) Inventors: Kripa Kiran Varanasi, Clifton Park, NY (US); Nitin Bhate, Rexford, NY (US); Gregory Allen O'Neil, Clifton Park, NY (US); Suryaprakash Ganti, Los Altos, CA (US); Judith Stein, Schenectady, NY (US); Tao Deng, Clifton Park, NY (US); Norman Arnold Turnquist, Sloansville, NY (US); Milivoj Konstantin Brun, Galway, NY (US); Farshad Ghasripoor, Scotia, NY (US); Kasiraman Krishnan, Clifton Park, NY (US); Christopher Fred Keimel, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/497,096

(22) Filed: Aug. 1, 2006

Related U.S. Application Data
(60) Provisional application No. 60/705,239, filed on Aug. 3, 2005.

(51) Int. Cl. F02C 7/08; F28F 13/18

(52) U.S. Cl. 60/39.5; 165/133; 165/134.1; 165/905; 165/913

(57) ABSTRACT

An apparatus for the transfer of heat is presented. The apparatus comprises a textured heat transfer surface disposed to promote condensation of a vapor medium to a liquid condensate, the surface comprising a plurality of surface texture features disposed on the heat transfer surface. The plurality of features has a median size, a median spacing, and a median height displacement such that the force exerted by the surface to pin a drop of condensate to the surface is equal to or less than an external force acting to remove the drop from the surface. Also included are heat pumps, systems for power generation, and distillation systems comprising the apparatus.

### CROSS REFERENCE TO RELATED APPLICATIONS

This application claims priority to U.S. Provisional Patent Application Ser. No. 60/705,239, filed Aug. 3, 2005.

### BACKGROUND

This invention relates to devices for efficient heat transfer. More particularly, this invention relates to the use of heat transfer surfaces having low surface energy to promote stable dropwise condensation, and devices incorporating these surfaces.

Condensation of a liquid phase from a vapor phase generally occurs when the vapor comes into contact with a surface having a temperature below the saturation temperature of the vapor, as commonly occurs in condenser devices used in power generation and refrigeration systems. The latent heat of vaporization is released during the condensation process, and this heat is transferred to the surface.

Two alternate mechanisms may govern a condensation process. In most cases, the condensing liquid (“condensate”) forms a film covering the entire surface; this mechanism is known as filmwise condensation. The film provides a considerable resistance to heat transfer between the vapor and the surface, and this resistance increases as the film thickness increases. In other cases, the condensate forms as drops on the surface, which grow on the surface, coalesce with other drops, and are shed from the surface under the action of gravity or aerodynamic forces, leaving freshly exposed surface upon which new drops may form. This so-called “dropwise” condensation results in considerably higher heat transfer rates than filmwise condensation, but dropwise condensation is generally an unstable condition that often becomes replaced by filmwise condensation over time.

Efforts to stabilize and promote dropwise condensation over filmwise condensation as a heat transfer mechanism in practical systems have often required the incorporation of additives to the condensing medium to reduce the tendency of the condensate to wet (i.e., form a film on) the surface, or the use of low-surface energy polymer films applied to the surface to reduce film formation. These approaches have drawbacks in that the use of additives may not be practical in many applications, and the use of polymer films may insert significant thermal resistance between the surface and the vapor. Polymer films may also suffer from low adhesion and durability in many aggressive industrial environments.

Therefore, advances in technologies that promote and stabilize dropwise condensation would be most welcome in the art, particularly if these technologies provided durability and did not substantially inhibit heat transfer between a surface and a vapor.

### BRIEF DESCRIPTION

Embodiments of the present invention meet these and other needs. One embodiment is an apparatus for the transfer of heat. The apparatus comprises a textured heat transfer surface disposed to promote condensation of a vapor medium to a liquid condensate, the surface comprising a plurality of surface texture features disposed on the heat transfer surface. The plurality of features has a median size, a median spacing, and a median height displacement such that the force exerted by the surface to pin (that is, to hold in contact) a drop of condensate to the surface is equal to or less than an external force acting to remove the drop from the surface.

Another embodiment is an apparatus for the transfer of heat. The apparatus comprises a textured heat transfer surface disposed to promote condensation of a vapor medium to a liquid condensate, the surface comprising a plurality of holes disposed in the surface. The plurality of holes has a median hole size, a, of up to about 10 micrometers, a median spacing, b, and a median height displacement, h, such that the ratio b/a is up to about 6 and the ratio h/a is in the range from about 0.5 to about 10. The heat transfer surface comprises a material having an inherent wettability sufficient to generate, with a condensate liquid, a contact angle of at least about 70 degrees.

Another embodiment is an apparatus for the transfer of heat. The apparatus comprises a textured heat transfer surface disposed to promote condensation of a vapor medium to a liquid condensate, the surface comprising a plurality of elevations disposed on the surface. The plurality of holes has a median hole size, a, of up to about 10 micrometers, and a median spacing, b, and a median height displacement, h, such that the ratio b/a is up to about 6 and the ratio h/a is in the range from about 0.5 to about 10. The heat transfer surface comprises a material having an inherent wettability sufficient to generate, with a condensate liquid, a contact angle of at least about 70 degrees.

Another embodiment is a heat pump. The heat pump comprises a working fluid capable of undergoing a phase change; and a condenser capable of receiving the working fluid. The condenser comprises a textured heat transfer surface disposed to promote condensation of a liquid condensate from the working fluid, and the surface comprises a plurality of surface texture features disposed on the heat transfer surface. The plurality of features has a median size, a, of up to about 10 micrometers, a median spacing, b, and a median height displacement, h, such that the ratio b/a is up to about 10 and the ratio h/a is in the range from about 0.5 to about 10, and the heat transfer surface comprises a material having an inherent wettability sufficient to generate, with the condensate liquid, a contact angle of at least about 70 degrees.

Another embodiment is a system for the generation of power. The system comprises a power generator unit configured to emit an exhaust fluid, and a condenser in fluid communication with the power generator unit, the condenser comprising a textured heat transfer surface disposed to promote condensation of a liquid condensate from the exhaust fluid. The surface comprises a plurality of surface texture features disposed on the heat transfer surface. The plurality of features has a median size, a, of up to about 10 micrometers, a median spacing, b, and a median height displacement, h, such that the ratio b/a is up to about 10 and the ratio h/a is in the range from about 0.5 to about 10, and the heat transfer surface comprises a material having an inherent wettability sufficient to generate, with the condensate liquid, a contact angle of at least about 70 degrees.

Another embodiment is a distillation system. The system comprises an evaporator configured to produce a vapor from a source liquid; and a condenser in fluid communication with the evaporator. The condenser comprises a textured heat transfer surface disposed to promote condensation of a liquid condensate from the vapor, and the surface comprises a plurality of surface texture features disposed on the heat transfer surface. The plurality of features has a median size, a, of up to about 10 micrometers, a median spacing, b, and a median height displacement, h, such that the ratio b/a is up to about 10 and the ratio h/a is in the range from about 0.5 to about 10, and the heat transfer surface comprises a material having an inherent wettability sufficient to generate, with the condensate liquid, a contact angle of at least about 70 degrees.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic cross-sectional view of an exemplary embodiment of the present invention;

FIG. 2 is a schematic cross-sectional view of another exemplary embodiment of the present invention;

FIG. 3 is a plot of surface area vs. feature parameters b/a and h/a;

FIG. 4 is a plot of maximum drop radius before roll-off as a function of the feature parameters b/a and h/a, where the features are elevations;

FIG. 5 is a plot of maximum drop radius before roll-off as a function of the feature parameters b/a and h/a, where the features are holes;

FIG. 6 is a plot of fraction of surface area available for drops to nucleate as Cassie-state drops as a function of the feature parameters b/a and h/a, where the features are elevations;

FIG. 7 is a plot of fraction of surface area available for drops to nucleate as Cassie-state drops as a function of the feature parameters b/a and h/a, where the features are holes;

FIG. 8 is a schematic cross-sectional view of an exemplary embodiment of the present invention;

FIG. 9 is a schematic view of a heat pump in accordance with embodiments of the present invention;

FIG. 10 is a schematic view of a system for power generation in accordance with an embodiment of the present invention; and

FIG. 11 is a schematic view of a distillation system in accordance with an embodiment of the present invention.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

To promote and maintain desirable dropwise condensation behavior, the condensation surfaces of heat transfer equipment should have a high specific surface area to provide a high density of sites for droplet nucleation; should have low wettability for the condensing liquid (often water, for example) to inhibit condensate film formation; and should promote rapid shedding (“roll-off”) of nucleated drops to maintain a high area of direct surface-vapor contact. In addition, the condensation surface should achieve the above while maintaining an acceptable level of thermal conductivity so that the temperature of the surface can be maintained at suitably low temperatures to sustain efficient condensation. Translating the above performance specifications into a workable design involves the resolution of certain trade-offs, which have been addressed by embodiments of the present invention.

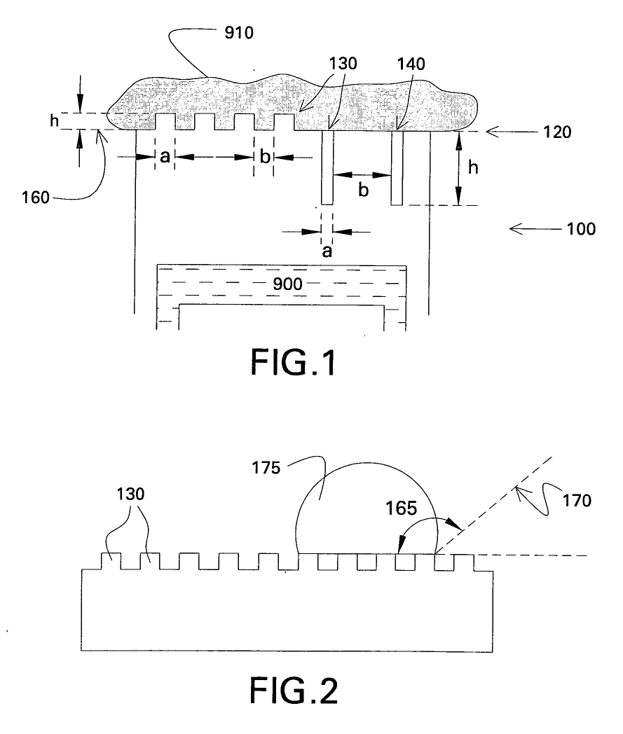

Referring to the drawings in general and to FIG. 1 in particular, it will be understood that the illustrations are for the purpose of describing a particular embodiment of the invention and are not intended to limit the invention thereto. Embodiments of the present invention include an apparatus 100 for the transfer of heat. The apparatus 100 comprises a textured heat transfer surface 120 disposed to promote condensation of a vapor medium to a liquid condensate. Generally, this means that surface 120 is disposed to allow contact with a vapor 910 from which a liquid is to be condensed. Surface 120 may be used in any shape convenient for a particular application; common shapes for heat exchange applications include flat plates and tubes. In certain embodiments, surface 120 comprises a metal, such as, for example, materials comprising iron, nickel, cobalt, chromium, aluminum, copper, titanium, platinum, or any other suitable metallic element. It will be appreciated that the term “metal” as used herein encompasses elemental metallic materials, alloys, and other compositions comprising metals such as aluminides and other intermetallic compositions. Moreover, where heat transfer performance specifications allow, surface 120 may comprise non-metallic materials, such as, for example, ceramics and semi-metals. Silicon is a particular example of a semi-metal; aluminum nitride and silicon carbide a particular examples of ceramics.

Surface 120 comprises a plurality of surface texture features 130 disposed on surface 120. In some embodiments the plurality of features 130 comprises at least one hole 140 disposed in surface 120, and in some embodiments, the plurality of features 130 comprises at least one elevation 150 disposed on the surface. As used herein, the term “hole” refers to any depression disposed in surface 120, including naturally occurring holes (e.g., pores) and artificially occurring holes (e.g. drilled holes). Features 130 comprise a height dimension (h), which represents the height of an elevation 150 above the surface base plane 160 or, in the case of holes 130, the depth to which the holes extend below the surface base plane 160. Features 130 further comprise a width dimension (a), referred to herein as feature “size.” Features 130 are disposed in a spaced-apart relationship characterized by a spacing dimension (b). Spacing dimension b is defined as the distance between the edges of two nearest-neighbor features. The plurality of features 130 has a median size, a median spacing, and a median height displacement such that the force exerted by the surface 120 to pin a drop of condensate of a pre-selected size to the surface 120 is equal to or less than an external force acting to remove the drop from the surface 120. The drop thus will be shed from the surface when it grows beyond the predetermined size, thereby clearing the surface 120 for more drops to nucleate. In this way, stable dropwise condensation may be maintained at surface 120, providing for markedly increased heat transfer efficiency over equipment that must rely on filmwise condensation. In some embodiments, the external force comprises the force of gravity acting on the drop, which may be readily calculated based on the value of the pre-selected drop size and density of the liquid. In other embodiments, the external force comprises a force exerted on the drop by a fluid (such as a fluid comprising air) in relative motion with respect to the surface, which force may be readily calculated using standard fluid dynamics techniques. Other force components, such as electromagnetic forces and the like, may be present depending on the nature of the application and of the liquid being condensed. Moreover, in some embodiments, the external force comprises a mechanical force. Such mechanical forces may be generated by vibrating the surface or by application of mechanical actuators to wipe drops from the surface, for example.

Where drop size is assumed to be much greater (for example, at least about 10 times) than the size (a) of features 130, an analysis of the physics of the interaction between a drop and surface 120 reveals that the ratios b/a and h/a have a significant effect on wetting behavior. See, for example, N. A. Patankar, Langmuir 2004, 20, 7097-7102. In this regime, the presence and configuration of features 130 on surface 120 have a significant effect on, for example, the wettability of surface 120, the wetting state of drops on the surface 120, and, under some circumstances, on the nucleation behavior at the surface 120. In some embodiments, the plurality of features has a median size, a, that is up to about 100 micrometers, to ensure that drops having a size of at least about 1 mm are at least about 10 times the median feature size. In particular embodiments, a is up to about 10 micrometers. A smaller median feature size may be desirable in some embodiments to inhibit fouling of the surface by the lodging of foreign particles within or upon features 130, for example.

The “liquid wettability”, or “wettability,” of a solid surface is determined by observing the nature of the interaction occurring between the surface and a drop of a given liquid disposed on the surface. A surface having a high wettability for the liquid tends to allow the drop to spread over a relatively wide area of the surface (thereby “wetting” the surface). In the extreme case, the liquid spreads into a film over the surface. On the other hand, where the surface has a low wettability for the liquid, the liquid tends to retain a well-formed, ball-shaped drop. In the extreme case, the liquid forms nearly spherical drops on the surface that easily roll off of the surface at the slightest disturbance.

In some embodiments of the present invention, features 130 have a size (e.g., a), shape (including, e.g. aspect ratio, h/a), and orientation (including, for example, spacing parameter b/a) selected such that the surface 120 has a low liquid wettability. One commonly accepted measure of the liquid wettability of a surface 120 is the value of the static contact angle 165 (FIG. 2) formed between surface 120 and a tangent 170 to a surface of a droplet 175 of a reference liquid at the point of contact between surface 120 and droplet 175. High values of contact angle 165 indicate a low wettability for the reference liquid on surface 120. The reference liquid may be any liquid of interest. In many applications, the reference liquid is water. In other applications, the reference liquid is a liquid that contains at least one hydrocarbon, such as, for example, oil, petroleum, gasoline, an organic solvent, and the like. Other examples include refrigerants such as chlorofluorocarbons (CFC's). Because wettability depends in part upon the surface tension of the reference liquid, a given surface may have a different wettability (and hence form a different contact angle) for different liquids. Surface 120, according to certain embodiments of the present invention, has a wettability sufficient to generate, with a reference liquid, a contact angle 165 of at least about 100 degrees, a contact angle that is considerably higher than that typically measured for flat (i.e., non-textured) metal surfaces. By establishing a relatively high contact angle in this range, the condensate may be maintained as drops, thereby inhibiting the formation of condensate films.

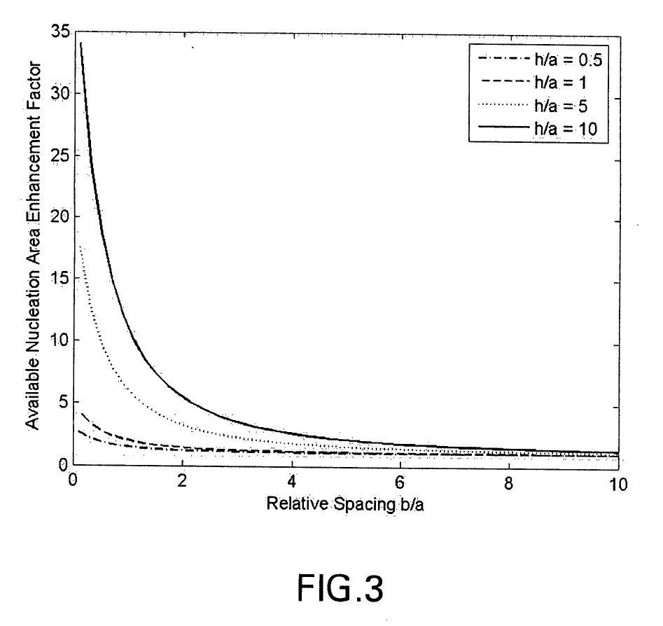

The texture features 130 also affect nucleation, in that they provide an increase in nucleation sites for droplets condensing on the surface. In general, this increase in sites is attributable to the increased surface area relative to a surface without texture. An analysis of surface area as a function of b/a and h/a indicates that the surface area is most strongly affected by feature geometry where b/a (the relative spacing between features) is relatively low. For example, FIG. 3 demonstrates the results of the analysis for the case where features 130 are elevations. Where b/a is below about 4, the area available for nucleation (plotted as a multiple of the surface area of a surface without features) is a strong function of feature aspect ratio (h/a). The highest enhancements are available where a surface comprises very high aspect ratio features that are spaced very closely together.

In particular embodiments, where the size of the features 130 is very small, the type of feature 130 present at surface 120 also plays a significant role in the promotion of nucleation. The critical drop nucleation radius, r*, is defined as that radius a nucleating drop must attain in order to remain as a stable liquid drop. This value is generally less than about 5 nanometers (nm) for water condensation under typically observed conditions, for example. Where feature size is less than about ten times r* (or less than about 50 nm, for example), convex features present an increased energy barrier to nucleation compared to the energy required for nucleation on macro-scale features, while concave features (such as holes, pores, and other depressions) present a lower energy barrier compared to macro-scale features. Thus, at small size scales for features 130, depressions present a more energetically favorable nucleation site than, for instance, convex elevations (e.g. cylindrical posts) do; in certain embodiments, the plurality of features a plurality of holes 140 having a feature size (i.e., hole diameter) of less than about 100 nm, such as less than about 50 nm, or in some particular embodiments, less than about 20 nm.

In addition to a high drop nucleation rate, effective heat transfer by dropwise condensation relies upon the continual shedding, or roll-off, of condensate drops from surface 120 so that surface 120 is continually exposed to vapor. Where density of features 130 is comparatively high, the desirable condition based purely on nucleation concerns, the area of contact between the drop and surface 130, and hence the forces pinning the drop to surface 130, will also be comparatively high. If gravity, aerodynamic drag, and other forces acting to dislodge the drop are exceeded by the pinning force, the drop will not be shed easily from surface 130. As described above, surface 120 is designed to allow rapid shedding of drops; that is, the surface 120 is designed such that force exerted by the surface 120 to pin a drop of condensate of a pre-selected size to the surface 120 is equal to or less than an external force (such as, for example, gravity, aerodynamic drag, and combinations of these) acting to remove the drop from the surface 120. Consideration of this point is aided by an understanding of how a drop of condensate interacts on surface 120.

A drop of liquid resides on a textured surface typically in any one of a number of equilibrium states. In the “Cassie” state, a drop sits on the peaks of the rough surface, trapping air pockets between the peaks, as is depicted by drop 175 in FIG. 2. In the “Wenzel” state, the drop wets the entire surface, filling the spaces between the peaks with liquid. Other equilibrium states generally can be envisioned as intermediate states between pure Cassie and pure Wenzel behavior. In general, because a significant portion of the Cassie-state drop is in contact with air pockets instead of the actual surface, the Cassie state is often more desirable for applications such as condensers and other heat transfer equipment, where a lowered adhesion of drops to the solid surface is desirable to promote droplet shedding. However, in these applications, where at least a portion of the liquid is disposed on surface 120 (FIG. 1) via condensation rather than impingement, at least some of the drops may likely exhibit Wenzel state behavior, especially those drops nucleating on the sides and interstices of elevations 150. In such cases roll-off may be more difficult to achieve than for pure Cassie drops, but surface 120 may still be designed to provide sufficiently low interaction between drop and features 130 to allow acceptable roll off, as described in more detail below.

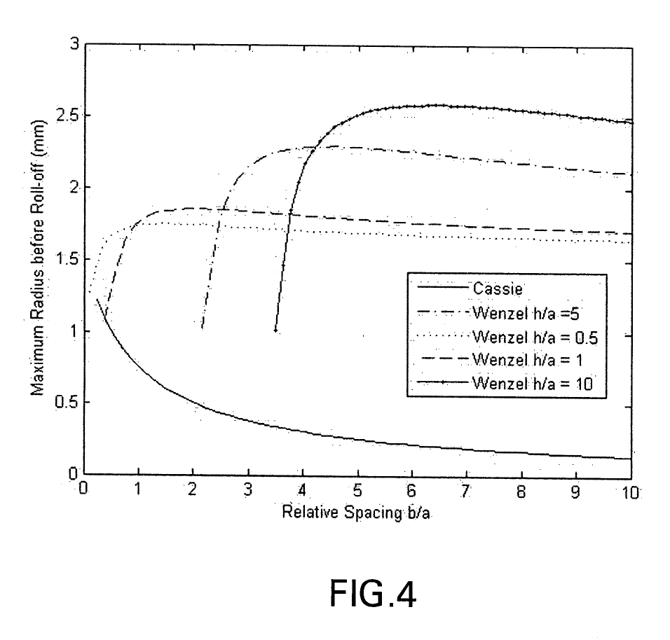

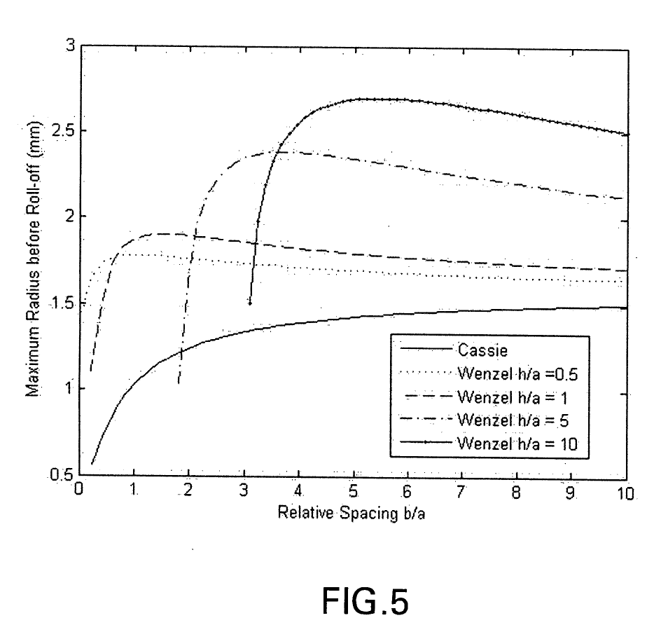

FIGS. 4 and 5 illustrate the mathematical relationship the present inventors have discovered between surface feature parameters and drop roll-off. The plots set forth in the figures assume that gravity is the only force acting on the drops, that the drops are held onto the surface primarily by forces acting on the drop-surface contact line, and that the contact angle for the liquid condensate on a smooth (non-textured) surface of the same material as the textured surface in question is about 110 degrees. In FIG. 4, the maximum drop radius prior to roll-off (under the influence of gravity on a vertical surface) is plotted as a function on b/a and h/a for the case where surface features are elevations. FIG. 5 shows the same plots for the case where the surface features are holes. The areas above the respective curves illustrate combinations of h/a and b/a that provide for roll-off of drops of an indicated size. For example, referring to FIG. 4, if the pre-selected drop size (radius) is 1 millimeter, drops in the Cassie state are expected to roll off for b/a of about 0.6 or greater (independent of h/a), and drops in the Wenzel state are expected to roll off for b/a up to about 2 where h/a is about 5. Referring to FIG. 5 and continuing the example for a 1 mm pre-selected drop size, a Cassie drop is expected to roll off for b/a of about 1 or greater, and Wenzel-state drops are expected to roll off for b/a up to about 2 where h/a is about 5. Those skilled in the art will appreciate that embodiments of the present invention include all combinations, and any subset thereof, of pre-selected drop size, b/a, and h/a that promote drop roll-off as predicted by the plots of FIGS. 4 and 5, regardless of whether a particular parameter range set is explicitly described herein.

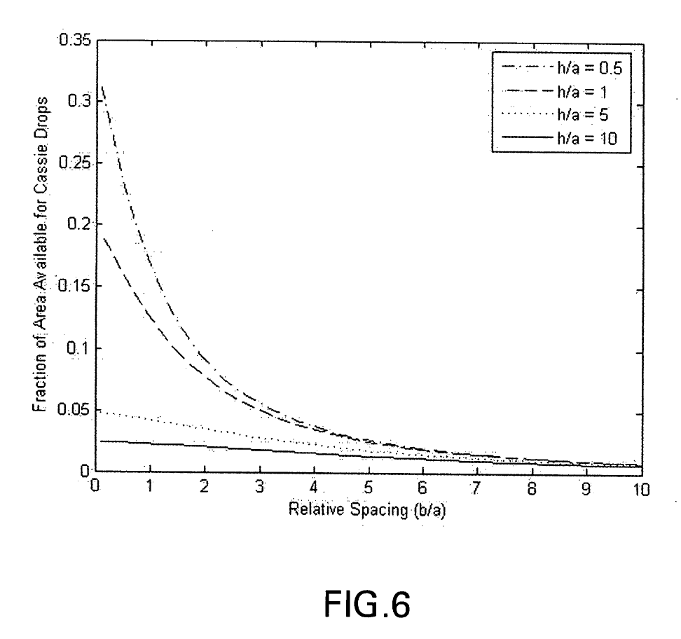

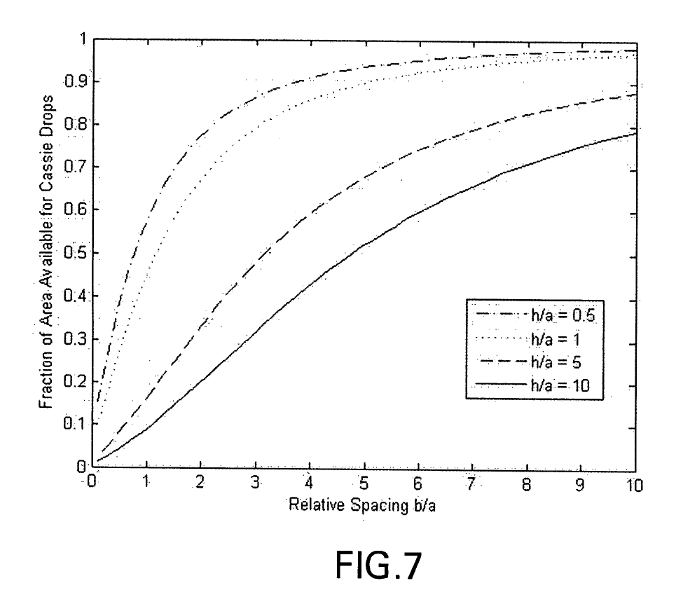

Further consideration of FIGS. 4 and 5 suggest that a Cassie-state drop will often have a smaller maximum size to roll-off (“critical drop size”) than will a Wenzel-state drop, for a given surface texture design (i.e., given values of b/a and h/a). It would be expected that in a given system, those drops that reside on surface 120 in the Cassie state will roll off surface 120 in a shorter period of time than those drops in the Wenzel state. Having a certain percentage of Cassie-state drops in the system is advantageous because, first, they roll off more quickly than the Wenzel-state drops and thus allow more nucleating events to occur, and second, when these drops roll off, they may sweep other drops (Cassie- or Wenzel-state) off of surface with them as they move over surface on their way to being shed. In general, drops that nucleate on the tops of features 130 will be the most likely Cassie-state candidate drops; drops nucleating elsewhere will most likely grow and remain as Wenzel-state drops. Thus, surface 120 may further be designed to promote the formation of a certain percentage of Cassie-state drops by ensuring that the area of feature tops is a significant percentage of the overall area available for drop nucleation. FIG. 6 shows the analysis of available area for Cassie-state drops as a function of h/a and b/a for the case where features are elevations, and FIG. 7 shows this same analysis for the case where features are holes. In certain embodiments, feature parameters such as h/a and b/a are selected such that at least some pre-selected percentage, such as at least about 2%, of the area of surface 120 exposed to the condensing vapor is available for Cassie-state drop formation.

The considerations described above represent a set of competing factors that are accounted for in designing a surface 120 in accordance with some embodiments of the present invention. For example, nucleation rate concerns urge for the use of the highest possible surface area: a high density of high aspect ratio features. However, the desire for rapid shedding generally urges the use of features having comparatively high relative spacing, and the desire for at least some Cassie-state drops urges the use of low aspect ratio features. Thus, the particular values selected for h/a and b/a represent the results of an analysis of competing mechanisms to arrive at an acceptable configuration.

In certain embodiments, where features 130 comprise elevations 150, the ratio b/a is up to about 10. In particular embodiments, b/a is up to about 6. In other embodiments, where features 130 comprise holes 140, b/a is up to about 20 and in particular embodiments is up to about 10. Selecting a relative spacing within these ranges puts the design in a range where, depending on the selection of h/a, the beneficial characteristics described above are readily achieved without unduly sacrificing performance. Regardless of whether features 130 are holes 140 or elevations 150, in some embodiments h/a is in the range from about 0.1 to about 100, and in particular embodiments h/a is in the range from about 0.5 to about 10. Note that at h/a less than 0.5, there is generally very little enhancement of surface area (a nucleation issue) while at h/a greater than 10 less than about 2% of the nucleation area is available for Cassie-state drops.

It should be noted that embodiments of the present invention contemplate any range contained within the respective ranges specified herein, regardless of whether the particular endpoints of the range are explicitly stated as viable endpoints. Moreover, embodiments of the present invention include any combination of parameter range limitations explicitly or implicitly set forth herein. For example, in particular embodiments, a is up to about 100 micrometers, b/a is up to about 6 and h/a is in the range from about 0.5 to about 10, in order to exploit more fully the advantages described above.

Numerous varieties of feature shapes are suitable for use as features 130. In some embodiments, at least a subset of the features 130 has a shape selected from the group consisting of a cube, a rectangular prism, a cone, a cylinder, a pyramid, a trapezoidal prism, and a segment of a sphere (such as a hemisphere or other spherical portion). These shapes are suitable whether the feature is an elevation 150 or a hole 140. As an example, in particular embodiments, at least a subset of the features comprises nanowires, which are structures that have a lateral size constrained to tens of nanometers or less and an unconstrained longitudinal size. Methods for making nanowires of various materials are well known in the art, and include, for example, chemical vapor deposition onto a substrate. Nanowires may be grown directly on surface 120 or may be grown on a separate substrate, removed from that substrate (for example, by use of ultrasonication), placed in a solvent, and transferred onto surface 120 by disposing the solvent onto the surface and allowing the solvent to dry.

In some embodiments, all of the features 130 in the plurality have substantially the same respective values for h, a, and b (“an ordered array”), though this is not a general requirement. For example, the plurality of features 130 may be a collection of features, such as nanowires, for instance, exhibiting a random distribution in at least one parameter such as feature size, feature shape, or feature spacing. In certain embodiments, moreover, the plurality of features is characterized by a multi-modal distribution (e.g., a bimodal or trimodal distribution) in h, a, b, or any combination thereof. Such distributions may advantageously provide reduced wettability in environments where a range of drop sizes is encountered. Estimation of the effects of h, a, and b on wettability are thus best performed by taking into account the distributive nature of these parameters. Techniques, such as Monte Carlo simulation, for performing analyses using variables representing probability distributions are well known in the art. Such techniques may be applied in designing features 130 for use in articles of the present invention.

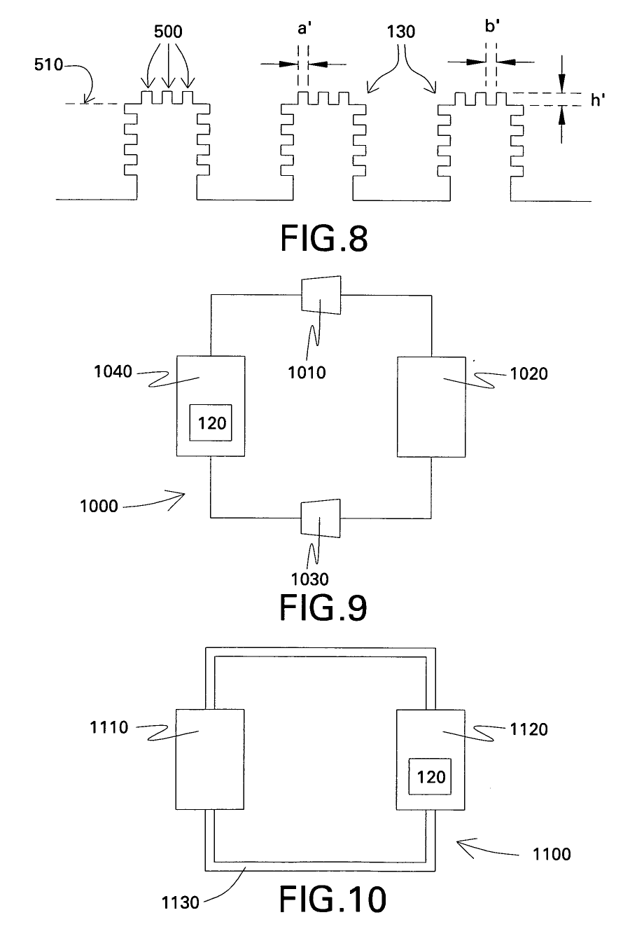

In certain applications, the presence of multiple size-scale features amplifies the low-wettability effects obtained on surfaces textured as described above, allowing for a broader acceptable range of feature size, shape, and orientation. As shown in FIG. 8, in some embodiments at least one feature 130 comprises a plurality of secondary features 500 disposed on the feature 130. In particular embodiments, secondary features 500 are disposed on each feature 130. Although the example depicted in FIG. 8 shows an ordered array of identical secondary features 500, such an arrangement is not a general requirement; random arrangements and other distributions in size, shape, and orientation may be appropriate for specific applications. Secondary features 500 may be disposed on any surface of features 130, including sides and top surfaces, and they may be disposed on the surface itself within spaces between features 130 as well. Secondary features 500 may be characterized by a height dimension h′ referenced to a feature baseline plane 510 (whether the secondary feature protrudes above plane 510 or is a cavity disposed in feature 130 to a depth h′ below plane 510), a width dimension a′, and a spacing dimension b′, all parameters defined analogously to a, b, and h described above. The parameters a′, b′, and h′ will often be selected based on the conditions particular to the desired application. In some embodiments a′, b′, and h′ are all within the range from about 1 nm to about 1000 nm.

Features 130 are disposed on surface 120 so as to maintain an acceptable degree of heat transfer between the surface 120 and a contacting vapor. In certain embodiments, features comprise a metal, such as, for instance one or more of the metals described above as suitable for fabrication of surface 120. However, if heat transfer performance requirements allow, other materials such as, for example, ceramics, semi-metals, and polymers, may be used in fabricating features 130. Anodized metal oxides are one example of a class of ceramics, and anodized aluminum oxide is a particular example of a potentially suitable material for use in embodiments of the present invention. Anodized aluminum oxide typically comprises columnar pores, and pore parameters such as diameter and aspect ratio may be closely controlled by the anodization process. If the thickness of the porous anodized metal oxide layer is kept sufficiently small, the thermal penalty may be negligible compared to the benefits offered by the presence of porous features.

Metals, ceramics, semi-metals, intermetallic materials, and certain polymers generally have moderate to high wettability, and thus the effect of surface texturing by providing features 130 as described herein may not always suffice to provide desired levels of wettability, absent some means of lowering the inherent wettability (that is, the wettability of a non-textured surface made of the material) of the features 130. The inherent wettability of the material used for surface 120 that will actually contact the liquid condensate, in some embodiments, is sufficiently low to generate, with a static drop of the liquid condensate, a contact angle of at least about 70 degrees; in some embodiments this angle is at least about 90 degrees, and in particular embodiments, the angle is at least about 110 degrees.

In some embodiments, surface 120 further comprises a surface energy modification material (not shown). This material is formed, in one embodiment, by overlaying a layer of material at surface 120, resulting in a coating disposed over features 130. Hydrophobic hardcoatings are one suitable option. As used herein, “hydrophobic hardcoatings” refers to a class of coatings that have hardness in excess of that observed for metals, and exhibit wettability resistance sufficient to generate, with a drop of water, a static contact angel of at least about 70 degrees. Diamond-like carbon (DLC) coatings, which typically have high wear resistance, have been applied to metallic articles to improve resistance to wetting (see, for example, U.S. Pat. No. 6,623,241). As a non-limiting example, fluorinated DLC coatings have shown significant resistance to wetting by water. Other hardcoatings such as nitrides, carbides, and oxides, may also serve this purpose. Particularly suitable materials candidates that have been demonstrated by the present inventors to produce contact angles of about 90 degrees and higher with water when deposited on smooth metal substrates include tantalum oxide, titanium carbide, titanium nitride, chromium nitride, boron nitride, chromium carbide, molybdenum carbide, titanium carbonitride, and zirconium nitride. These hardcoatings, and methods for applying them, such as chemical vapor deposition (CVD), physical vapor deposition (PVD), etc., are known in the art, and may be of particular use in harsh environments. Fluorinated materials, such as fluorosilanes, are also suitable coating materials that exhibit low wettability for certain liquids, including water. Finally, if conditions allow, the coating may comprise a polymeric material. Examples of polymeric materials known to have advantageous resistance to wetting by certain liquids include silicones, fluoropolymers, urethanes, acrylates, epoxies, polysilazanes, aliphatic hydrocarbons, polyimides, polycarbonates, polyether imides, polystyrenes, polyolefins, polypropylenes, polyethylenes or mixtures thereof.

Alternatively, the surface energy modification material may be formed by diffusing or implanting molecular, atomic, or ionic species into the surface 120 to form a layer of material having altered surface properties compared to material underneath the surface modification layer. In one embodiment, the surface energy modifying material comprises ion-implanted material, for example, ion-implanted metal. Ion implantation of metallic materials with ions of boron (B), nitrogen (N), fluorine (F), carbon (C), oxygen (O), helium (He), argon (Ar), or hydrogen (H) may lower the surface energy (and hence the wettability) of the implanted material. See, for example, A. Leipertz et al., “Dropwise Condensation Heat Transfer on Ion Implanted Metallic Surfaces,” http://www.ltt.uni-erlangen.de/inhalt/pdfs/tk_gren.pdf; and Xuehu Ma et. al, “Advances in Dropwise Condensation Heat Transfer: Chinese Research”, Chemical Engineering Journal, 2000, volume 78, 87-93.

In one embodiment, a diffusion hardening processes such as a nitriding process or a carburizing process is used to dispose the surface energy modification material, and thus the surface energy modification material comprises a nitrided material or a carburized material. Nitriding and carburizing processes are known in the art to harden the surface of metals by diffusing nitrogen or carbon into the surface of the metal and allowing strong nitride-forming or carbide-forming elements contained within the metal to form a layer of reacted material or a dispersion of hard carbide or nitride particles, depending on the metal composition and processing parameters. Nitriding processes known in the art include ion nitriding, gas nitriding, and salt-bath nitriding, so named based upon the state of the nitrogen source used in the process. Similarly, a variety of carburizing processes are known in the art. These processes have shown a remarkable potential for lowering metal surface energy. In one example, the contact angle (measured using water as reference liquid) of 403 steel having a surface finish of 32 microinches was increased from about 60 degrees to about 115 degrees by ion nitriding. A preliminary observation of the surface of the nitrided surface applied to mirror-finish specimens suggests that the nitriding process may deposit nano-scale features at the surface in addition to reducing the inherent surface energy of the metal; the presence of such features may amplify the ability of the surface to resist wetting, enhancing the performance of the coating over one having similar composition but a smooth, feature-free structure.

The surface energy modification layer may be applied after features 130 have been provided on surface 120. Alternatively, features 130 may be formed after applying surface energy modification layer to surface 120. The choice of order will depend on the particular processing methods being employed and the materials being used for features 130 and surface 120. It should be noted that the use of surface energy modification material in combination with the use of the textures as described herein may result in surfaces having significantly higher liquid contact angles than those expected where the surface energy modification material is used without the texturing, that is, where the material is applied to a smooth surface. The enhanced resistance to wetting provided by embodiments of the present invention, where texture and surface modification are combined, may promote drop shedding by rolling of the drop, while without texturing the drops may merely slide off the surface. The roll-off of drops is preferable to slide-off because rolling drops are less likely to leave a film of liquid on the surface during the removal process, thereby desirably increasing the direct contact between vapor and surface. These advantages are further illustrated by examples presented herein.

Features 130 can be fabricated and provided to apparatus 100 by a number of methods. In some embodiments, features 130 are fabricated directly on surface 120 of apparatus 100. In other embodiments, features 130 are fabricated separately from surface 120 and then disposed onto surface 120. Disposition of features 130 onto surface 120 can be done by individually attaching features 130, or the features may be disposed on a sheet, foil or other suitable medium that is then attached to the surface 120. Attachment in either case may be accomplished through any appropriate method, such as, but not limited to, welding, brazing, mechanically attaching, or adhesively attaching via epoxy or other adhesive.

The disposition of features 130 may be accomplished by disposing material onto the surface of the apparatus, by removing material from the surface, or a combination of both depositing and removing. Many methods are known in the art for adding or removing material from a surface. For example, simple roughening of the surface by mechanical operations such as grinding, grit blasting, or shot peening may be suitable if appropriate media/tooling and surface materials are selected. For example, grit blasting metal surfaces using media having a mesh size in the range from about 32 to about 220 has produced surfaces having textures sufficient to produce enhanced resistance to wetting by water compared to the resistance exhibited by the surfaces without grit blasting, especially where a surface energy modification material is applied to the roughened (grit blasted) surface, as described above. Such operations will generally result in a distribution of randomly oriented features on the surface, while the size-scale of the features will depend significantly on the size of the media and/or tooling used for the material removal operation. Lithographic methods are commonly used to create surface features on etchable surfaces, including metal surfaces. Ordered arrays of features can be provided by these methods; the lower limit of feature size available through these techniques is limited by the resolution of the particular lithographic process being applied.

Electroplating methods are also commonly used to add features to surfaces. An electrically conductive surface may be masked in a patterned array to expose areas upon which features are to be disposed, and the features may be built up on these exposed regions by plating. This method allows the creation of features having higher aspect ratios than those commonly achieved by etching techniques. In particular embodiments, the masking is accomplished by the use of an anodized aluminum oxide (AAO) template having a well-controlled pore size. Material is electroplated onto the substrate through the pores, and the AAO template is then selectively removed; this process is commonly applied in the art to make high aspect ratio features such as nanorods. Nanorods of metal and metal oxides may be deposited using commonly known processing, and these materials may be further processed (by carburization, for example) to form various ceramic materials such as carbides. As will be described in more detail below, coatings or other surface modification techniques may be applied to the features to provide even better wettability properties.

Micromachining techniques, such as laser micromachining (commonly used for silicon and stainless steels, for example) and etching techniques (for example, those commonly used for silicon) are suitable methods as well. Such techniques may be used to form cavities (as in laser drilling) as well as protruding features. Where the plurality of features 320 includes cavities 300, in some embodiments surface 120 comprises a porous material, such as, for example, an anodized metal oxide. Anodized aluminum oxide is a particular example of a porous material that may be suitable for use in some embodiments. Anodized aluminum oxide typically comprises columnar pores, and pore parameters such as diameter and aspect ratio may be closely controlled by the anodization process, using process controls that are well known to the art to convert a layer of metal into a layer of porous metal oxide.

In short, any of a number of deposition processes or material removal processes commonly known in the art may be used to provide features to a surface. As described above, the features may be applied directly onto surface 120 of apparatus 100, or applied to a substrate that is then attached to surface 120.

Additional aspects of constructing apparatus 100 (FIG. 1) are widely known in the art of heat exchanger design and construction and are not repeated herein. Generally, apparatus 100 further comprises surface 120 in thermal communication with a cooling medium 900 to maintain the temperature of surface 120 at a temperature sufficient to sustain condensation from the vapor 910 in contact with surface 120. In certain embodiments, cooling medium 900 is a liquid, such as water; while in other embodiments, cooling medium 900 is a gas such as air. In an exemplary embodiment, apparatus 100 is a condenser, such as a shell-and-tube heat exchanger of the type commonly used in power generation and chemical processing systems, including, for instance, steam turbine power generation facilities. In such cases, surface 120 is the surface of the tubes upon which condensate forms as exhaust fluid is flowed through apparatus 100.

An embodiment of the present invention includes a heat pump 1000 (FIG. 9). The basic design and operation of heat pumps is well known in the art. Generally, heat pump 1000 flows a working fluid through an expander 1010 to reduce the temperature of the working fluid. The cooled fluid is then passed through an evaporator 1020, during which time the working fluid may absorb heat from the environment surrounding evaporator 1020 (such as, for instance, the air from the interior chamber of a commercial refrigerator). The working fluid is then compressed by compressor and sent to condenser 1040, whereupon the condensation action releases the heat absorbed in the evaporator 1020 and during compression. This condenser comprises the apparatus 100 (FIG. 1) described above, in that it comprises surface 120 as set forth herein. Other embodiments include devices comprising heat pump 1000, including such devices as air conditioners and refrigerators.

Further embodiments of the present invention, as shown in FIG. 10, include a system 1100 for the generation of power, comprising a power generator unit 1110 and a condenser 1120 in fluid communication with the power generator unit 1010. Typically the fluid communication is established via the flow of an exhaust fluid 1130 from unit 1110 to condenser 1120. Condenser 1120 comprises surface 120 as described herein. Other aspects of system 1100, such as the location and design of condensate pumps, valves, and other components are well known in the art of power generation system design and are not repeated herein. Unit 1110 can be any power generation equipment, such as a nuclear reactor, a steam turbine, or a fuel cell, that typically employs one or more condensers as part of the power generation cycle.

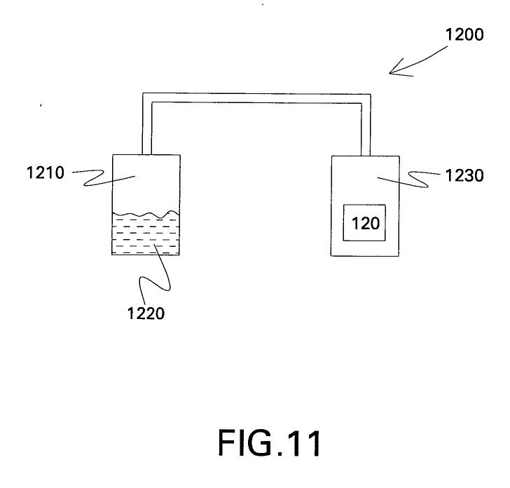

Another embodiment of the present invention is a distillation system, as shown schematically in FIG. 11. System 1200 comprises an evaporator 1210 configured to effect the generation of a vapor from a source liquid 1220. The vapor is transported to condenser 1230, which is disposed in fluid communication with evaporator 1210. Condenser 1230 comprises surface 120 as described herein; the condensate forms at, and rolls off of, surface 120, whereupon it is collected. In some embodiments, system 1200 is a desalination system, wherein the source liquid 1220 may be seawater, for example, and the condensate may be potable water that is collected for consumption. Ancillary details of distillation systems in general and desalination systems in particular are well known in the art and are not repeated here.

### EXAMPLES

The following example is presented to further illustrate exemplary embodiments of the invention and should not be construed as limiting the invention in any way.

### Example 1

An apparatus for heat transfer is designed. A maximum allowable drop diameter of up to 3 mm prior to roll-off is determined to be allowable to ensure proper levels of heat transfer. An aluminum tube is to be used as a heat transfer surface, and the surface of the tube that will contact the vapor to be condensed is anodized, using a process known in the art, to provide a layer of anodized aluminum oxide (AAO) of 100 micrometer thickness (h). The anodization process selected to perform this work can be manipulated to provide columnar pores having a median pore diameter (a) of about 10 micrometers with a median edge-to-edge spacing (b) of about 30 micrometers. Thus h/a is about 10 and b/a is about 3. Referring to FIG. 5, the selected process will provide a surface configured to effect roll-off at the desired maximum size for both Wenzel-state and Cassie-state drops. The AAO surface is treated with a very thin layer of fluorosilane, using a vapor deposition method known to the art, prior to use in the apparatus to ensure the inherent wettability of the surface material is sufficiently low to generate, with a static drop of the liquid water condensate, a contact angle of at least about 70 degrees.

### Example 2

An experimental test apparatus was designed to measure heat transfer associated with condensation of steam. The test setup consisted of a steam generator, a condensing chamber, and a chill block, one end of which is exposed to the steam and the other end to cooler circulating water. The test sample was mounted onto the chill block so that steam condensed onto the surface of the sample. Heat transfer and associated heat transfer coefficients are determined by measuring the temperatures along the length of the block, the surface of the sample, and the temperature of the steam.

Silicon wafers (4″ diameter) with different surface properties were tested in the above apparatus. Sample A was a regular silicon wafer with water contact angle of about 43 degrees (hydrophilic), and served as a baseline. Sample B was coated with tridecafluoro-1,1,2,2-tetrahydrooctyl-trichlorosilane (fluorosilane) via vapor deposition, to increase its water contact angle to 110 degrees (hydrophobic). Samples C and D had unique surface textures in accordance with embodiments of the present invention, and were fabricated using standard photolithography techniques, followed by deep reactive ion etching. Sample C had rectangular prism post features of width 3 micrometers and spacing of 1.5 micrometers. Sample D had rectangular prism post features of width 3 micrometers and spacing 6 micrometers. The aspect ratio of the posts was about 3 for both samples C and D. The samples were tested under identical conditions in the above apparatus, and each exhibited different condensation behavior. Because of the hydrophilic nature of the surface, filmwise condensation was observed on sample A and the measured heat transfer coefficient was 2.23 kW/m² K. The condensate on sample B consisted of large drops that slid along the surface; the measured heat transfer coefficient was 2.85 kW/m² K, only slightly larger than that of sample A. On samples C and D, stable dropwise condensation was observed, and the droplets were observed to roll off the surface rather than sliding. The measured heat transfer coefficients were 4.61 kW/m² K and 13.48 kW/m² K, respectively. The enhancement in heat transfer coefficients over the baseline sample (sample A) is about 1.3 for sample B, about 2 for sample C, and about 6 for sample D. This enhancement can be attributed to an increased nucleation area and superior roll-off properties of the textured substrates as discussed above. The average drop size on sample D was observed to be smaller than that of sample C because of its larger relative spacing (b/a). This resulted in an higher heat transfer coefficient for sample D over C.

### Example 3

A pipe composed of 6061 aluminum with a diameter of about one inch was first polished with fine sandpaper and then coated with anodized aluminum oxide (AAO) via an anodization process. The surface consisted of pores that were on average 90 nm in diameter, 500 nm in depth and a typical edge-to-edge spacing of about 10 nm. This specimen was then coated with fluorosilane via vapor deposition as in Example 1. When the surface was exposed to steam, stable dropwise mode of condensation was observed, with droplets being shed from the surface by rolling off.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An apparatus for the transfer of heat, the apparatus comprising:
a textured heat transfer surface disposed to promote condensation of a vapor medium to a liquid condensate, the surface comprising a plurality of surface texture features disposed on the heat transfer surface;
wherein the plurality of features has a median size, a median spacing, and a median height displacement such that the force exerted by the surface to pin a drop of condensate to the surface is equal to or less than an external force acting to remove the drop from the surface.

2. The apparatus of claim 1, wherein the plurality of features has a median size, a, and a median spacing, b, such that the ratio b/a is up to about 20.

3. The apparatus of claim 1, wherein the plurality of features has a median size, a, and a median spacing, b, such that the ratio b/a is up to about 10.

4. The apparatus of claim 3, wherein b/a is up to about 6.

5. The apparatus of claim 1, wherein the plurality of features has a median height displacement, h, and wherein the ratio h/a is in the range from about 0.1 to about 100.

6. The apparatus of claim 5, wherein h/a is in the range from about 0.5 to about 10.

7. The apparatus of claim 1, wherein the plurality of features has a median size, a, that is up to about 100 micrometers.

8. The apparatus of claim 7, wherein a is up to about 10 micrometers.

9. The apparatus of claim 1, wherein the plurality of features comprises a random distribution in at least one parameter selected from the group consisting of feature size, feature shape, and feature spacing.

10. The apparatus of claim 1, wherein the plurality of features has a multi-modal distribution in at least one parameter selected from the group consisting of h, a, and b.

11. The apparatus of claim 1, wherein at least one feature further comprises a plurality of secondary features disposed on the feature.

12. The article of claim 11, wherein each feature comprises a plurality of secondary features disposed on the feature.

13. The apparatus of claim 1, wherein the plurality of features comprises an ordered array of features.

14. The apparatus of claim 1, wherein the features comprise a surface energy modification material.

15. The apparatus of claim 14, wherein the surface energy modification material comprises ion-implanted metal.

16. The apparatus of claim 15, wherein the ion-implanted metal comprises implanted ions of at least one element selected from the group consisting of B, N, F, O, C, He, Ar, and H.

17. The apparatus of claim 14, wherein the surface energy modification material comprises a nitrided material or a carburized material.

18. The apparatus of claim 14, wherein the surface energy modification material comprises a coating disposed over the features.

19. The apparatus of claim 18, wherein the coating comprises at least one material selected from the group consisting of a hydrophobic hardcoat, a fluorinated material, and a polymer.

20. The apparatus of claim 19, wherein the hydrophobic hardcoat comprises a material selected from the group consisting of DLC, fluorinated DLC, tantalum oxide, titanium carbide, titanium nitride, chromium nitride, boron nitride, chromium carbide, molybdenum carbide, titanium carbonitride, and zirconium nitride.

21. The apparatus of claim 19, wherein the fluorinated material comprises fluorosilane.

22. The apparatus of claim 19, wherein the polymer comprises at least one selected from the group consisting of silicones, fluoropolymers, urethanes, acrylates, epoxies, polysilazanes, aliphatic hydrocarbons, polyimides, polycarbonates, polyether imides, polystyrenes, polyolefins, polypropylenes, and polyethylenes.

23. The apparatus of claim 1, wherein the plurality of features comprises at least one hole disposed in the surface.

24. The apparatus of claim 23, wherein the surface comprises a porous anodized metal oxide material.

25. The apparatus of claim 24, wherein the metal oxide comprises aluminum oxide.

26. The apparatus of claim 23, wherein the plurality of features comprises a plurality of holes having a median diameter of up to about 100 nm.

27. The apparatus of claim 1, wherein the plurality of features comprises at least one elevation disposed on the surface.

28. The apparatus of claim 27, wherein the elevation comprises a shape selected from the group consisting of a cube, a rectangular prism, a cone, a cylinder, a pyramid, a trapezoidal prism, and a segment of a sphere.

29. The apparatus of claim 1, wherein the heat transfer surface comprises one selected from the group consisting of a flat plate and a tube.

30. The apparatus of claim 1, wherein the heat transfer surface comprises a metal.

31. The apparatus of claim 1, wherein the heat transfer surface comprises a material having an inherent wettability sufficient to generate, with a condensate liquid, a contact angle of at least about 70 degrees.

32. The apparatus of claim 1, wherein the external force comprises a gravitational force.

33. The apparatus of claim 1, wherein the external force comprises a force exerted on the drop by a fluid in relative motion with respect to the surface.

34. The apparatus of claim 1, wherein the external force comprises a mechanical force.

35. The apparatus of claim 1, wherein the apparatus is a shell-and-tube heat exchanger.

36. A distillation system comprising the apparatus of claim 1.

37. A power generation system comprising the apparatus of claim 1.

38. A heat pump comprising the apparatus of claim 1.

39. An apparatus for the transfer of heat, the apparatus comprising:
a textured heat transfer surface disposed to promote condensation of a vapor medium to a liquid condensate, the surface comprising a plurality of holes disposed in the surface;
wherein the plurality of holes has a median hole size, a, of up to about 10 micrometers, and a median spacing, b, and a median height displacement, h, such that the ratio b/a is up to about 6 and the ratio h/a is in the range from about 0.5 to about 10, and
wherein the heat transfer surface comprises a material having an inherent wettability sufficient to generate, with a condensate liquid, a contact angle of at least about 70 degrees.

40. An apparatus for the transfer of heat, the apparatus comprising:
a textured heat transfer surface disposed to promote condensation of a vapor medium to a liquid condensate, the surface comprising a plurality of elevations disposed on the surface;
wherein the plurality of elevations has a median size, a, of up to about 10 micrometers, and a median spacing, b, and a median height displacement, h, such that the ratio b/a is up to about 6 and the ratio h/a is in the range from about 0.5 to about 10, and
wherein the heat transfer surface comprises a material having an inherent wettability sufficient to generate, with a condensate liquid, a contact angle of at least about 70 degrees.

41. A heat pump, comprising:
a working fluid capable of undergoing a phase change; and
a condenser capable of receiving the working fluid, the condenser comprising a textured heat transfer surface disposed to promote condensation of a liquid condensate from the working fluid, the surface comprising a plurality of surface texture features disposed on the heat transfer surface;
wherein the plurality of features has a median size, a, of up to about 10 micrometers, a median spacing, b, and a median height displacement, h, such that the ratio b/a is up to about 10 and the ratio h/a is in the range from about 0.5 to about 10, and
wherein the heat transfer surface comprises a material having an inherent wettability sufficient to generate, with the condensate liquid, a contact angle of at least about 70 degrees.

42. A device comprising the heat pump of claim 41, wherein the device comprises an air conditioner or a refrigerator.

43. A system for the generation of power, comprising:
a power generator unit configured to emit an exhaust fluid, and;
a condenser in fluid communication with the power generator unit, the condenser comprising a textured heat transfer surface disposed to promote condensation of a liquid condensate from the exhaust fluid, the surface comprising a plurality of surface texture features disposed on the heat transfer surface;
wherein the plurality of features has a median size, a, of up to about 10 micrometers, a median spacing, b, and a median height displacement, h, such that the ratio b/a is up to about 10 and the ratio h/a is in the range from about 0.5 to about 10, and
wherein the heat transfer surface comprises a material having an inherent wettability sufficient to generate, with the condensate liquid, a contact angle of at least about 70 degrees.

44. The system of claim 43, wherein the power generator unit is a nuclear reactor, a steam turbine, or a fuel cell.

45. A distillation system, comprising:
an evaporator configured to produce a vapor from a source liquid; and
a condenser in fluid communication with the evaporator, the condenser comprising a textured heat transfer surface disposed to promote condensation of a liquid condensate from the vapor, the surface comprising a plurality of surface texture features disposed on the heat transfer surface;
wherein the plurality of features has a median size, a, of up to about 10 micrometers, a median spacing, b, and a median height displacement, h, such that the ratio b/a is up to about 10 and the ratio h/a is in the range from about 0.5 to about 10, and
wherein the heat transfer surface comprises a material having an inherent wettability sufficient to generate, with the condensate liquid, a contact angle of at least about 70 degrees.

46. The distillation system of claim 45, wherein the distillation system is a water desalination system.
